(19) United States
(12) Patent Application Publication
(10) Pub. No.: US 2009/0179574 A1
(43) Pub. Date: Jul. 16, 2009

(54) Backlight module of light emitting diode

(76) Inventor: Hsiu-Hui Chang, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,822

(22) Filed: Jan. 16, 2008

(51) Int. Cl. H05B 37/02

(52) U.S. Cl. 315/192

(57) ABSTRACT

This invention provides a dynamic control method for LED backlight module, in which each LED of a backlight module is connected with respective parallel circuit, and each parallel circuit is connected in series together. Then, only a single current source is used to supply the required power for light emitting of the whole LEDs series, and the brightness of each LED is controlled by controlling the current flowing through each LED with the parallel circuit according to flow dividing method. In this manner, the connection in the whole circuit design and its control become easier and simpler.

### BACKGROUND OF THE INVENTION

1. Field of the Invention

The present invention relates to a dynamic control method for LED(light emitting diode) backlight module, particularly to a dynamic control method for LED backlight module in which the brightness of each LED of a backlight module is controlled by controlling the current flowing through each LED with a parallel circuit according to the flow dividing method, so as to further enhance the contrast of a liquid crystal device (LCD).

2. Brief Description of the Prior Art

Along with the coming of information age, desktop and notebook personal computer have been becoming widespread and the video or image display device is apt to become more light-weighted and thinner. Conventional cathode ray tube (CRT) display device, though with some strong points, is however bulky in volume and heavier due to inherent structure of the electronic gun inside, and the radiation is also harmful to user's eyes in use.

Therefore, the liquid crystal display having the merits of light-weighted, thin, high brightness, low power consumption and few radiations gradually take the place of the conventional CRT as the main stream in the display consumer market in recent years.

In view of its diversified advantages, the liquid crystal display has been widely applied in a variety of electronic products including personal digital assistant (PDA) with small size panel, mobile phone, digital video camera, digital camera, display with large size panel, notebook PC and television set etc. Inasmuch as the liquid crystal molecule cannot illuminate itself, backlight module has to be provided for the liquid crystal panel as the planar light source so as to display the image information shown on the liquid crystal panel. Thus, backlight module becomes an indispensable key component in the liquid crystal display.

The backlight module in the early stage has a plurality of cold cathode ray tubes arranged within it so that the light emitted from the cold cathode ray tubes serves as the light sources required for the liquid crystal display. Accompanying with the wide-spreading situation of light emitting diode, light emitting diode is also applied in the backlight module due to its superior properties of low power consumption, low power input, longer service lifetime, so that the light emitted from it similarly serves as the light sources required for the liquid crystal display.

Generally, several light emitting diodes (LEDs) on the backlight module are connected in series first, and one current source and a feedback circuit is used to control the brightness of the LEDs. However, the brightness of each of the serially connected LEDs cannot independently be controlled. It is this reason that a method of LED individually controlled by respective current source is developed, in which the brightness of each LED is controlled in each area, and the display contrast is further controlled.

Although the design of the above LED controlled by individual current source can achieve the predetermined effectiveness of controlling the luminance of backlight of each area, some defects in this design has been founded in practical application.
1. a lot of current sources have to be utilized in this design so as to achieve the purpose of individual control on each LED. In this case, the whole circuit design becomes so complicated that not only inconvenience is caused in the connection or combination process of manufacturing, but also significant inconvenience is encountered on the control due to the factor of multi-current sources.
2. As the LED will change its color according to the variation of temperature due to the phenomena of showing different color at different temperature, the temperature escalation of LED due to the sustained application of light emitting of a LED will cause color deviation of the light emitted from the LED such that the image displayed on the panel is influenced by the color deviation.

### SUMMARY OF THE INVENTION

This invention provides a dynamic control method for LED backlight module, in which each LED of a backlight module is connected with respective parallel circuit, and each parallel circuit is connected in series together. Then, only a single current source is used to supply the required power for light emitting of the whole LEDs series, and the brightness of each LED is controlled by controlling the current flowing through each LED with the parallel circuit according to the flow dividing method. In this manner, the connection in the whole circuit design and its control become easier and simpler.

### BRIEF DESCRIPTION OF THE DRAWINGS

FIG. 1 is a schematic view of the circuit of the present invention.

FIG. 2 is a schematic view of the whole assembled circuit of the present invention.

### DETAILED DESCRIPTION OF THE PREFERRED EMBODIMENTS

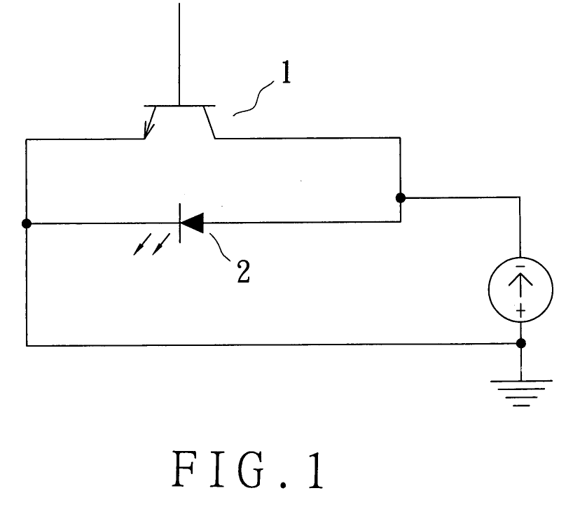

Firstly referring to FIG. 1 of a schematic view of the circuit of the present invention, a parallel circuit (1) is connected with a LED (2) to control the current passing through the LED (2) according to the flow dividing method. The parallel circuit (1) can be a field effect transistor (MOS-FET) which controls the current passing through the LED (2) by the ON-OFF of voltage so as to control the brightness of LED (2). Alternatively, the parallel circuit (1) can be a bipolar junction transistor (BJT) which controls the current passing through the LED (2) by the ON-OFF of current so as to control the brightness of LED (2).

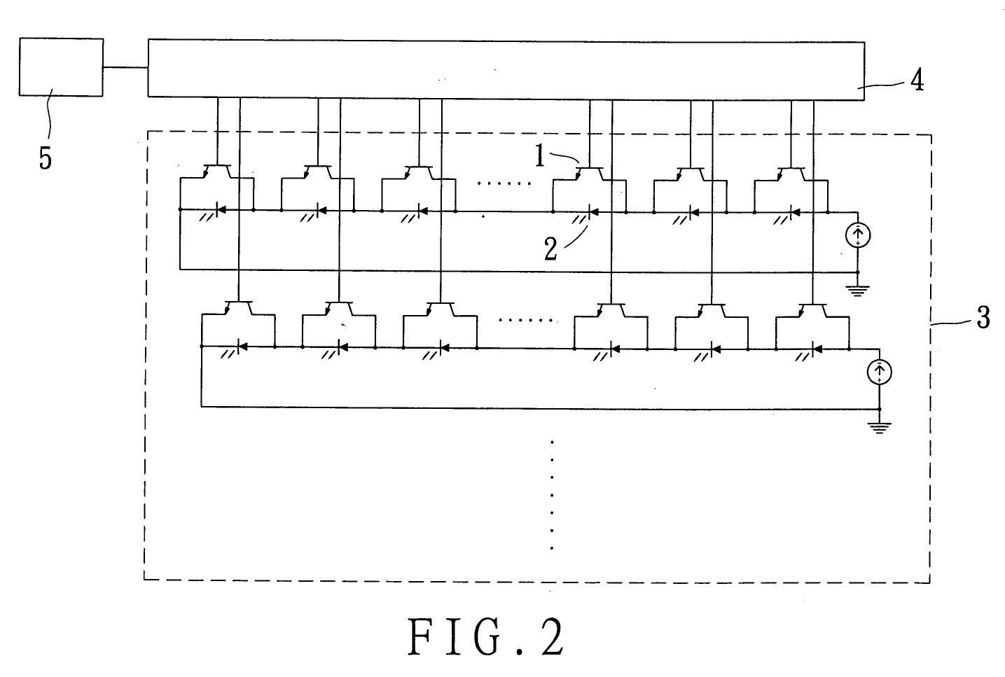

With this configuration, as shown in FIG. 2 of a schematic view of the whole assembled circuit of the present invention, a plurality of LEDs each of which is connected with respective parallel circuit (1) are connected in series to form a backlight module (3). Furthermore, a control circuit (4) is used to control the parallel circuit (1) such that the current passing through each LED (2) is changed to achieve the purpose of controlling the brightness of each LED in individual area or range of the backlight module (3), furthermore, to supply the illuminating light required for the liquid crystal display.

In addition, the control circuit (4) is connected with a temperature sensor (5) which detects the temperature of each LED (2) or the ambience and transmits the on-time signal of temperature thus sensed immediately to the control circuit (4). The control circuit (4) controls the parallel circuit (1) according to the temperature variation sensed by the temperature sensor (5) to change the current flowing through each LED (2) so as to adjust the luminance of the light emitted from each LED (2). Furthermore, the color deviation occurred on each LED (2) due to the change of temperature can be amended.

Based on the foregoing, this invention surely has the following advantages when comparing with prior art.
1. In this invention, each LED is connected with respective parallel circuit and only a single current source is used to supply the required power for light emitting of the whole LEDs series, and the current flowing through individual LED is controlled by the parallel circuit according to the flow dividing method. Thus, the brightness of each LED is controlled by means of the above current control. In this manner, the connection in the whole circuit design and its control become easier and simpler.
2. In this invention, the control circuit is connected with a temperature sensor which detects the temperature of each LED or the ambience and transmits the on-time signal of temperature sensed immediately to the control circuit. The control circuit controls the parallel circuit according to the temperature variation sensed by the temperature sensor to change the current flowing through each LED so as to adjust the luminance of the light emitted from each LED. Furthermore, the color deviation occurred on each LED due to the change of temperature can be amended.

Summing up above, the embodiment of this invention can reach expected effectiveness, and the specific configurations disclosed herein have yet not seen in the prior art of the same category of product, even has not been opened to the public before application.

While the present invention has been described with preferred embodiment in conjunction with the accompanying drawings, the preferred embodiment and the drawings are purely for the convenience of description only, and are not intended to be restrictive of the scope of the present invention. It is noted that various modifications and variations can be made without departing from the spirit of the present invention. In this case, these modifications and variations are considered to be within the scope of the present invention.

What is claimed is:

1. A dynamic control method for LED backlight module, wherein each LED of a backlight module is connected with respective parallel circuit, and each parallel circuit is connected in series together such that the brightness of each LED of the backlight is controlled by controlling the current flowing through each LED with the parallel circuit according to flow dividing method.

2. A dynamic control method for LED backlight module as claimed in claim 1, wherein the parallel circuit is a field effect transistor (MOS-FET) which controls the current passing through the LED (2) by the ON-OFF of voltage.

3. A dynamic control method for LED backlight module as claimed in claim 1, wherein the parallel circuit is a bipolar junction transistor (BJT) which controls the current passing through the LED (2) by the ON-OFF of current.

4. A dynamic control method for LED backlight module as claimed in claim 1, wherein the control circuit is connected with a temperature sensor and used by the parallel circuit to control variations of currents.
